(19) United States
(12) Patent Application Publication
(10) Pub. No.: US 2026/0099879 A1
(43) Pub. Date: Apr. 9, 2026

(54) DECENTRALIZED TRANSACTION SYSTEM INCORPORATING MULTIPLE DISTRIBUTED LEDGER ARRANGEMENTS, AND METHOD OF OPERATING THEREOF

(71) Applicant: METTALEX LIMITED, Bury St Edmunds (GB)

(72) Inventors: Chirag Maliwal, Bury St Edmunds (GB); Mehul Surendra Gaidhani, Bury St Edmunds (GB); Humayun Munir Sheikh, Bury St Edmunds (GB)

(21) Appl. No.: 18/909,126

(22) Filed: Oct. 8, 2024

(51) Int. Cl. G06Q 40/04

(52) U.S. Cl. CPC G06Q 40/04

(57) ABSTRACT

Disclosed is decentralized transaction system (100) comprising computing nodes (CNs) (102a-c) configured to implement platform (104) for enabling autonomous agent-based (AB) trading using decentralized order book (OB) model. Each CN is communicably coupled to its corresponding distributed ledger arrangement (DLA), user device(s) (UD(s)) (108), and agent database (AD) (110) comprising autonomous agents (AAs) (112a-c). CN(s) is configured to: receive requests for locking funds, and for placing trades, from respective UDs; send notifications to AD regarding placement of trades, for respective AAs associated with UDs; create communication interface for enabling P2P communication between AAs; facilitate, via processing interface (PI), AB trade matching via platform; employ PI for enabling OB-based trade (OB-BT) locking and bilateral balance verification (BBV), upon matching of AAs; and employ PI for enabling OB-BT execution according to one of: funds push process, funds pull process, upon successful trade locking and BVV.

### TECHNICAL FIELD

The present disclosure relates to decentralized transaction systems incorporating multiple distributed ledger arrangements. Moreover, the present disclosure relates to decentralized transaction methods of operating the decentralized transaction systems.

### BACKGROUND

In the ever-evolving landscape of decentralized finance (DeFi), decentralized exchange (DEX) serves as a fundamental component reshaping the way financial transactions occur in the digital age. The decentralized exchange refers to a peer-to-peer marketplace that facilitates direct transactions between users (such as traders) without a central authority or an intermediary (such as banks, brokers, and the like). The DeFi DEXs are built on blockchain technology which are used to store the financial transactions, verify validity of such financial transactions, and record the financial transactions.

Generally, performing the financial transactions in a decentralized manner between multiple blockchains pose several challenges. Each blockchain operates differently and independently as each blockchain from amongst the multiple blockchains have differences in terms of communication protocols, chain implementation (like, consensus methods), and so forth. Furthermore, interoperability amongst multiple blockchains is challenging as a single consensus is not maintained, which becomes difficult to track the financial transactions. Moreover, there are trust issues over different blockchains while performing the financial transaction. Hence, these challenges lead to complexity in terms of executing the financial transaction.

Therefore, in light of the foregoing discussion, there exists a need to overcome the aforementioned drawbacks.

### SUMMARY

The aim of the present disclosure is to provide a decentralized transaction system incorporating multiple distributed ledger arrangements, and method of operating thereof that when executing trading between two different distributed ledger arrangements, the trading is either fully completed or fully reversed in case of a failure. The aim of the present disclosure is achieved by decentralized transaction system incorporating multiple distributed ledger arrangements, and method of operating thereof, as defined in the appended independent claims to which reference is made to. Advantageous features are set out in the appended dependent claims.

Throughout the description and claims of this specification, the words "comprise", "include", "have", and "contain" and variations of these words, for example "comprising" and "comprises", mean "including but not limited to", and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a decentralized transaction system, in accordance with an embodiment of the present disclosure;

FIG. 2 shows an exemplary process flow of enabling order book-based trade execution according to a funds push process, in accordance with an embodiment of the present disclosure;

FIG. 3 shows an exemplary process flow of enabling order book-based trade execution according to a funds pull process, in accordance with an embodiment of the present disclosure; and

FIG. 4 illustrates a flowchart depicting steps of a decentralized transaction method of operating a decentralized transaction system, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a decentralized transaction system comprising a plurality of computing nodes configured to implement a platform for enabling autonomous agent-based trading using a decentralized order book model, wherein each computing node is communicably coupled to its corresponding distributed ledger arrangement from amongst a plurality of distributed ledger arrangements, at least one user device, and an agent database comprising a plurality of autonomous agents, and wherein at least one computing node is configured to:

receive a first request for locking a first amount of funds, from a first user device, wherein upon receiving the first request, a first smart contract executing on a first distributed ledger arrangement is configured to lock the first amount of funds;

receive a second request for locking a second amount of funds, from a second user device, wherein upon receiving the second request, a second smart contract executing on a second distributed ledger arrangement is configured to lock the second amount of funds;

receive, from the first user device, a third request for placing a first trade on the platform;

receive, from the second user device, a fourth request for placing a second trade on the platform;

send, to the agent database, a first notification regarding placement of the first trade on the platform, for a first autonomous agent associated with a first user of the first user device;

send, to the agent database, a second notification regarding placement of the second trade on the platform, for a second autonomous agent associated with a second user of the second user device;

create a communication interface for enabling peer to peer communication between the first autonomous agent and the second autonomous agent via the platform;

facilitate via a processing interface, agent-based trade matching via the platform, wherein the first autonomous agent is matched with the second autonomous agent when trade parameters of the first trade and trade parameters of the second trade match each other;

employ the processing interface for enabling order book-based trade locking and bilateral balance verification via the platform, when the first autonomous agent is matched with the second autonomous agent; and

employ the processing interface for enabling order book-based trade execution via the platform, upon successful trade locking and bilateral balance verification, wherein the order book-based trade execution is enabled according to one of: a funds push process, a funds pull process.

The aforementioned first aspect provides the decentralized transaction system for autonomous agent-based trading using the decentralized order book model. Herein, each computing node is communicably coupled to its corresponding distributed ledger arrangement, which enhances an ability of the decentralized transaction system to decentralize. In this regard, a responsibility of maintaining and verifying the trades is distributed within the decentralized transaction system, thereby enhancing security and trustworthiness. Furthermore, as each computing node processes the trading on its corresponding distributed ledger arrangement, it makes the decentralized transaction system scalable, while reducing delays in processing the trading. Additionally, the decentralized transaction system is user-friendly, as corresponding autonomous agents are used to automate the trading, thus making it accessible for corresponding users. Moreover, the funds push process ensures that the trading between users takes place as intended. The funds pull process is a fail-safe way for respective users to procure their funds back in case any of the autonomous agents encounters any error in middle of the trading.

This decentralized transaction system comprises smart contracts that are executed on corresponding distributed ledger arrangement to perform cross-chain trading. The smart contract is immutable and tamper-proof, which prevents a malicious user or third-party attacks from interfering with the normal execution of the contract. Hence, the smart contracts are able to efficiently handle trading with the plurality of distributed ledger arrangements. When using the smart contract with the decentralized transaction system, the whole transaction process is transparent, traceable and cannot be tampered with, thus improving the transaction process with respect to conventional computer system.

Furthermore, bilateral verification is used to maintain and verify the trades in the decentralized transaction system. Moreover, the decentralized transaction system enables peer-to-peer communication to foster efficient and direct interaction between the first autonomous agent and the second autonomous agent associated with the first user and the second user. This makes the decentralized transaction system more secure, less prone to attacks, transparency of transactions, and immutable.

In a second aspect, the present disclosure provides a decentralized transaction method of operating a decentralized transaction system that comprises a plurality of computing nodes configured to implement a platform for enabling autonomous agent-based trading using a decentralized order book model, wherein each computing node is communicably coupled to its corresponding distributed ledger arrangement from amongst a plurality of distributed ledger arrangements, at least one user device, and an agent database comprising a plurality of autonomous agents, the method comprising:

receiving a first request for locking a first amount of funds, from a first user device, wherein upon receiving the first request, a first smart contract executing on a first distributed ledger arrangement is configured to lock the first amount of funds;

receiving a second request for locking a second amount of funds, from a second user device, wherein upon receiving the second request, a second smart contract executing on a second distributed ledger arrangement is configured to lock the second amount of funds;

receiving, from the first user device, a third request for placing a first trade on the platform;

receiving, from the second user device, a fourth request for placing a second trade on the platform;

sending, to the agent database, a first notification regarding placement of the first trade on the platform, for a first autonomous agent associated with a first user of the first user device;

sending, to the agent database, a second notification regarding placement of the second trade on the platform, for a second autonomous agent associated with a second user of the second user device;

creating a communication interface for enabling peer to peer communication between the first autonomous agent and the second autonomous agent via the platform;

facilitating via a processing interface, agent-based trade matching via the platform, wherein the first autonomous agent is matched with the second autonomous agent when trade parameters of the first trade and trade parameters of the second trade match each other;

employing the processing interface for enabling order book-based trade locking and bilateral balance verification via the platform, when the first autonomous agent is matched with the second autonomous agent; and

employing the processing interface for enabling order book-based trade execution via the platform, upon successful trade locking and bilateral balance verification, wherein the order book-based trade execution is enabled according to one of: a funds push process, a funds pull process.

The second aspect of the present disclosure offers the decentralized transaction method that leverages the decentralized transaction system's capabilities. Herein, by combining features such as locking funds in corresponding distributed ledger arrangements, the first notification and the second notification, and the order book-based trade locking and bilateral verification, the decentralized transaction method ensures that trade are executed securely and transparently on the platform. Furthermore, as each computing node processes the trading on its corresponding distributed ledger arrangement, it makes the decentralized transaction system scalable, while reducing delays in processing the trading. Additionally, the decentralized transaction method is user-friendly, trading is automated due to the usage of autonomous agents corresponding to a user. Moreover, the funds push process ensures that the trading between users takes place as intended. The funds pull process is a fail-safe way for respective users to procure their funds back in case any autonomous agents encounter any error in middle of the trading.

Throughout the present disclosure, the term "decentralized transaction system" as used herein refers to a networked arrangement of the plurality of computing nodes interconnected through a data communication network. The plurality of computing nodes includes computing arrangements that are operable to respond to, and process instructions and data therein. The computing arrangements may include, but are not limited to, a microprocessor, a microcontroller, a complex instruction set computing (CISC) microprocessor, a reduced instruction set (RISC) microprocessor, a very long instruction word (VLIW) microprocessor, an artificial intelligence (AI) computing engine based on hierarchical networks of variable-state machines, or any other type of processing circuit. Furthermore, the computing arrangements can be one or more individual processors, processing devices and various elements associated with a processing device that may be shared by other processing devices. Additionally, the computing arrangements are arranged in various architectures for responding to and processing the instructions that drive the decentralized transaction system. Moreover, the plurality of computing nodes is communicably coupled to each other via the data communication network that allows for communication among said plurality of computing nodes. Notably, the data communication network refers to an arrangement of interconnected, programmable and/or non-programmable components that, when in operation, facilitate data communication between one or more electronic devices and/or databases. Furthermore, the data communication network may include, but is not limited to, a peer-to-peer (P2P) network, a hybrid peer-to-peer network, local area networks (LANs), radio access networks (RANs), metropolitan area networks (MANs), wide area networks (WANs), all of or a portion of a public network such as global computer network known as the Internet®, a private network, a cellular network and any other communication system. Additionally, the data communication network employs wired or wireless communication that can be carried out via one or more known protocols.

Throughout the present disclosure, the term "platform" refers to a digital environment that serves as a foundation for enabling various functionalities, particularly autonomous agent-based trading. Optionally, the platform comprises a technological infrastructure that facilitates and coordinates trading activities.

Throughout the present disclosure, the term "decentralized order book model" refers to a system for recording and managing placement of trades in a distributed and transparent manner. In this regard, the decentralized order book model is used to maintain information about buy and sell trades across the plurality of computing nodes, using corresponding distributed ledger arrangements, in the data communication network. In other words, the decentralized order book is a trading mechanism where buy and sell trades are matched through the plurality of computing nodes that are arranged in a distributed manner, rather than being centralized in a single location or controlled by a single entity. A technical effect of such usage of corresponding distributed ledger arrangements is that it is useful in scalability of the decentralized transaction system. In the decentralized order book model, a user of the at least one user device can lock funds, place trades, and execute trades without a need for intermediaries or central authorities. This helps the user of the at least one user device achieves a price of the trade they want more closely, thus improving transparency.

Throughout the present disclosure, the term "distributed ledger arrangement" refers to a ledger (for example, such as a database) comprising entries recording operations and/or smart contracts (such as the first smart contract and the second smart contract), with a timestamp. In other words, the term "distributed ledger arrangement" refers to a database of entries or blocks of data such as a blockchain. The distributed ledger arrangement ensures that all data and models are tamper-proof and transparent to the plurality of autonomous agents. Optionally, the corresponding distributed ledger arrangement of each computing node is consensually shared and synchronized in a decentralized form across the plurality of autonomous agents. A technical effect of using the corresponding distributed ledger arrangement is that it facilitates faster processing of the transactions in the decentralized transaction system when compared to a decentralized transaction system that uses a single distributed ledger arrangement. Moreover, due to the usage of corresponding distributed ledger arrangement, transactional data of only corresponding users are stored by corresponding autonomous agents, thus reducing overhead and thereby, saving memory space within the decentralized transaction system.

Optionally, the plurality of computing nodes implements corresponding distributed ledger technology (DLT). Beneficially, the DLT allows for secure and transparent record-keeping of the trades, without a need for intermediaries or centralized authorities. In this regard, the DLT uses an encryption layer (for example, such as a cryptographic layer), to secure the transaction and enable access only to autonomous agents of authorized users.

Herein, the term "smart contract" refers to a software contract configured to run automatically when one or more conditions are met in the system. As an example, the smart contract may comprise automation of execution of an agreement such that all parties involved have certainty of an outcome. In other words, the term "smart contract" also refers to a digital version of a conventional contract which is executed automatically when one or more conditions (namely, terms) are met in the system. It will be appreciated that a given smart contract may be one or more computer algorithms, or a transaction protocols, where these may be executed via computer programs, respectively intended to automatically execute events or actions according to agreed terms (the contract terms). Herein, the term "given smart contract" encompasses the first smart contract and the second smart contract. Optionally, the smart contracts at least one of: controls, records, documents events or actions according to the agreed terms.

Throughout the present disclosure, the term "agent database" refers to a structured repository of the plurality of autonomous agents. In this regard, each autonomous agent from amongst the plurality of autonomous agents is an individual program that has independent agent databases. Moreover, each user of the at least one user device has its own autonomous agent which is irreplaceable directly by the system. Herein, the term "autonomous agent" as used herein, relates to computational entities or software programs that are designed to perform tasks or make decisions autonomously, without direct human intervention. The autonomous agent could perceive their operational environment, analyze information, and take actions based on at least one of: predefined rules, algorithms, learning capabilities of the autonomous agent. Optionally, the autonomous agent is an autonomous economic agent (AEA). Optionally, each of the autonomous agent from amongst the plurality of autonomous agents has predefined roles in the autonomous agent-based trading, thus enabling automation and efficient execution of trades.

Throughout the present disclosure, the term "user device" as used herein refers to an electronic device that a given user interacts with to access the decentralized transaction system. Examples of the user device may include, but are not limited to, a smartphone, a tablet, a laptop, or a desktop computer. The user device act as an interface for the given user to engage with the decentralized transaction system. Herein, the first user device is associated with the first user and initiates the first request. Herein, the second user device is associated with the second user and initiates the second request.

The first user of the first user device initiates the first request for locking, i.e., secure, the first amount of funds. Such initiation of the first request by the first user is used to maintain control over their funds. The first user device generates and sends the first request, wherein first request comprises the first amount of funds, and optionally comprises at least one of: a destination of locking the first amount of funds, a purpose of locking the first amount of funds, a transaction ID of the first amount of funds, credentials of the first user. Herein, the term "first request" refers to a first instance of such a request in a given transaction. The first request is transmitted over the data communication network. Moreover, the phrase "locking the first amount of funds" refers to reserving a certain amount of funds so that it cannot it be used for any other transaction until one or more conditions are met, or the autonomous agent-based trading is completed. Beneficially, locking of the first amount of funds provides security and trust in the transaction, as both the first user and the second user of the first user device and the second user device, respectively, can be assured that the funds are available and will be used according to the agreed terms. Examples of the funds may include, but are not limited to, cryptocurrency funds, tokenized assets funds, index funds, hedging funds, and digital money. Subsequently, when the at least one computing node receives the first request, said first request is processed and verified to ensure that the first amount of funds is available, and then locking said first amount of funds in the first smart contract. Such locking of the first amount of funds in the first smart contract ensures that the first amount of funds is used only as intended by the first user of the first user device.

The second user of the second user device initiates the second request for locking, i.e., secure, the second amount of funds. Such initiation of the second request by the second user is used to maintain control over their funds. The second user device generates and sends the second request, wherein second request comprises the second amount of funds, and optionally comprises at least one of: a destination of locking the second amount of funds, a purpose of locking the second amount of funds, a transaction ID of the second amount of funds, credentials of the second user. Herein, the term " second request" refers to a second instance of such a request in a given transaction. The second request is transmitted over the data communication network. Moreover, the phrase "locking the second amount of funds" refers to reserving a certain amount of funds so that it cannot it be used for any other transaction until one or more conditions are met, or the autonomous agent-based trading is completed. Beneficially, locking of the second amount of funds provides security and trust in the transaction, as both the first user and the second user of the first user device and the second user device, respectively, can be assured that the funds are available and will be used according to the agreed terms. Subsequently, when the at least one computing node receives the second request, said second request is processed and verified to ensure that the second amount of funds is available, and then locking said second amount of funds in the second smart contract. Such locking of the second amount of funds in the second smart contract ensures that the second amount of funds are used only as intended by the second user of the second user device.

The term "trade" refers to a specific transaction that results from a given request, wherein the term "given request" encompasses the first trade and the second trade. Herein, the first trade and the second trade refer to a specific transaction that results from the first request and the second request, respectively. In this regard, the first trade and the second trade involve exchange of assets or securities as per the first request and the second request made by the first user of the first user device and the second user of the second user device, respectively. In an example, the first request may be to purchase 50 tokens. In another example, the second request may be to sell 50 tokens.

The at least one computing node is configured to receive the third request from the first user device for placing the first trade. In this regard, when the first user initiates the third request, the first smart contract on the distributed ledger arrangement is employed to secure the funds for the first trade. Furthermore, when the first user initiates the third request, the distributed ledger arrangement is configured to automatically initiate and deploy the first smart contract in accordance with trade parameters received for the third request. Accordingly, when the second user initiates the fourth request, the distributed ledger arrangement is configured to automatically initiate and deploy the second smart contract in accordance with the trade parameters received for the third request.

Optionally, a given request is received from at least one of: a software application executing on a given user device, a software application executing on each computing device that is communicably coupled to the given user device, a cloud-based software application, a digital twin of the given user a digital representation of the given user, an artificial intelligence model (AI-model) based on a Large Language Model (LLM). Herein, the term "given request" refers to the first request, the second request, the third request, and the fourth request.

In some instances, the software application may be implemented as a trading interface application. In such instances, a trader may use the trading interface application on their computing node to make the given request to execute a given trade. In other instances, the software application may be implemented as an algorithmic trading bot that is communicably coupled to a trading account of the given user. Optionally, the cloud-based software application could be a price tracking and analysis tool provided by the platform. Optionally, the service request can be received from the digital twin that refers to a virtual representation of the given user. Optionally, the given digital twin employs market data analysis, machine learning, and algorithmic decision-making to assist the given user in executing the given request. For example, the digital twin could be a trading assistant bot or an AI model that interacts with the platform on the given user's behalf.

Throughout the present disclosure, the term "notification" refers to an automated message that facilitates communication. Herein, the autonomous agent getting notified is an action that results from the autonomous agent monitoring particular smart contracts (such as the smart contracts associated with the corresponding user) for change of state (such as the data stored in the smart contract). The first notification and the second notification facilitate communication between the first user device and the second user device, the first autonomous agent and the second autonomous agent, and the platform. In this regard, when the first user places the first trade using the first user device, the at least one computing node receives the third request. The at least one computing node then formulates the first notification and sends said first notification to the agent database. The agent database identifies the first autonomous agent associated with the first user and provides the first notification thereto.

In this regard, when the second user places the second trade using the second user device, the at least one computing node receives the fourth request. The at least one computing node then formulates the second notification and sends the second notification to the agent database. The agent database identifies the second autonomous agent associated with the second user and provides the second notification thereto.

Throughout the present disclosure, the term "communication interface" refers to an interface that enables direct and secure interaction between the first autonomous agent and the second autonomous agent involved in the first trade and the second trade. The communication interface is automatically created once the decentralized transaction system identifies that the first and the second autonomous agent are required to interact with each other to fulfil the third request and the fourth request. The communication interface may also be referred to a piece of software or a set of instructions which when executed enables the first autonomous agent and the second autonomous agent to communicate. The communication interface serves to exchange crucial trade-related information, such as trade parameters and digital signatures, which are essential for the verification and execution of the first trade and the second trade. A technical effect of this P2P communication is that it enhances efficiency and security of the autonomous agent-based trading. Herein, the digital signature serves as a cryptographic proof of its identity and authorization.

In this regard, the first autonomous agent is configured to send trade parameters of the first trade, and optionally, a first digital signature of the first autonomous agent to the second autonomous agent in the agent database. Similarly, the second autonomous agent is configured to send trade parameters of the second trade, and optionally, a second digital signature of the second autonomous agent to the first autonomous agent in the agent database. In this regard, the first autonomous agent associated with the first user represents on behalf of the first user, and the second autonomous agent associated with the second user represents on behalf of the second user, to perform the P2P decentralized transaction. The communication interface ensures that these crucial trade elements are exchanged in a secure and efficient manner, promoting effective peer-to-peer interaction between the autonomous agents.

Throughout the present disclosure, the term "processing interface" refers to a software module or component that allows for the processing and management of various operations related to agent-based trade matching within the decentralized transaction system. In this regard, the processing interface is used by the at least one computing node to facilitate handling of coordination, validation, and execution of the agent-based trade matches and related actions. Moreover, the second autonomous agent, is configured to perform the trade match. Furthermore, the matching between the trade parameters of the first trade and trade parameters of the second trade involves comparing the trade parameters of the first trade and the trade parameters of the second trade to determine if there's a suitable trade match between the trade parameters of the first trade and the second trade. Once the matching trade parameter of the first trade and the second trade is identified, the second autonomous agent is configured to send the first digital signature along with the trade parameters of the first trade and the trade parameters of the second trade. It will be appreciated that the aforementioned information is sent to the second smart contract for further verification and execution of the trade.

Optionally, the trade parameters of the first trade comprise at least one of: a timeframe needed for completion of the first trade, a cost associated with the first trade, a quantity associated with the first trade, a quality associated with the first trade, a customized instruction associated with the first trade, an asset type, a preference of the autonomous agents, or delivery terms. A technical effect of the aforementioned feature is that the trade parameters enable defining and controlling the first trade, from its initial setup and execution through to its verification, compliance, and transfer of funds. This is beneficial in conducting the first trade smoothly, efficiently, and according to requirement of the first user. In this regard, the phrase "timeframe needed for completion of the first trade " refers to a specific duration within which the first trade should be completed. Optionally, the phrase "cost associated with the first trade" refers to a monetary value associated with executing the first trade. Optionally, the phrase "quantity associated with the first trade" refers to an amount or volume of assets involved in the first trade. Optionally, the "quality associated with the first trade" refers to a desired level of excellence or standard for the first trade. Optionally, the phrase "customized instruction associated with the first trade" refers to specific instructions or requirements for the execution of the first trade. Optionally, the term "asset type" refers to a type or a category of asset involved in the first trade. Optionally, the phrase "preference of the autonomous agents" refers to a favored choice or an inclination of the first autonomous agent and the second autonomous agent involved in the first trade. Optionally, the term "delivery terms" refers to conditions or terms for the delivery of the traded goods or services comprised in the first trade. Beneficially, the first set of trade parameters enables flexibility and adaptability in tailoring the execution of the first trade to meet specific requirements and preferences.

Optionally, the trade parameters of the second trade comprise at least one of: a timeframe needed for completion of the second trade, a cost associated with the second trade, a quantity associated with the second trade, a quality associated with the second trade, a customized instruction associated with the second trade, an asset type, a preference of the autonomous agents, or delivery terms. A technical effect of the aforementioned feature is that the trade parameters enable defining and controlling the second trade, from its initial setup and execution through to its verification, compliance, and transfer of funds. This is beneficial in conducting the second trade smoothly, efficiently, and according to requirement of the second user. In this regard, the phrase "timeframe needed for completion of the second trade" refers to a specific duration ensures timely execution of the second trade within a specific time window. Optionally, the phrase "cost associated with the second trade" refers to a monetary value associated with executing the second trade. Optionally, the phrase "quantity associated with the second trade" refers to an amount or volume of assets involved in the second trade. Optionally, the "quality associated with the second trade" refers to a desired level of excellence or standard for the second trade. Optionally, the phrase "customized instruction associated with the second trade" refers to specific instructions or requirements for the execution of the second trade. Optionally, the term "asset type" refers to a type or a category of asset involved in the second trade. Optionally, the phrase "preference of the autonomous agents" refers to a favored choice or an inclination of the first autonomous agent and the second autonomous agent involved in the second trade. Optionally, the term "delivery terms" refers to conditions or terms for the delivery of the traded goods or services comprised in the second trade. Beneficially, the second set of trade parameters enables flexibility and adaptability in tailoring the execution of the second trade to meet specific requirements and preferences.

The order book-based trade locking ensures that once the first autonomous agent is matched with the second autonomous agent, i.e., the first and the second autonomous agents agree on the trade, the terms (for example, such as prices and amounts) are fixed and the funds that are involved are reserved. The processing interface is configured to lock the trade based on order book data, thus ensuring that the terms of the trade cannot be changed. Moreover, the bilateral balance verification involves checking balance of the first user of the first user device and the second user of the second user device to ensure that each of them have required funds to complete the autonomous agent-based trading. This is performed by checking corresponding account associated with the first autonomous agent and the second autonomous agent for enough funds to fulfil requirement of the autonomous agent-based trading.

Optionally, for enabling the order book-based trade locking and bilateral balance verification,

the first autonomous agent is configured to lock the first trade and to send a corresponding first trade lock acknowledgment along with a balance information of the first amount of funds, to the second autonomous agent;

the second autonomous agent is configured to verify the balance information of the first amount of funds, to lock the second trade, and to send a corresponding second trade lock acknowledgment along with a balance information of the second amount of funds, to the first autonomous agent;

the first autonomous agent is configured to lock funds for the first trade from amongst the first amount of funds that are pre-locked in the first smart contract, and the second autonomous agent is configured to lock funds for the second trade from amongst the second amount of funds that are pre-locked in the second smart contract;

upon receiving a response confirming said locking of the funds for the first trade, from the first smart contract, the first autonomous agent is configured to send details of said locking of the funds for the first trade along with an updated balance information of the first amount of funds which remain in the first smart contract upon said locking of the funds for the first trade, to the second autonomous agent; and

upon receiving a response confirming said locking of the funds for the second trade, from the second smart contract, the second autonomous agent is configured to send details of said locking of the funds for the second trade along with an updated balance information of the second amount of funds which remain in the second smart contract upon said locking of the funds for the second trade, to the first autonomous agent.

In this regard, interaction between the first autonomous agent and the second autonomous agent that are involved in the autonomous agent-based trading is described, where they are configured to coordinate locking of a given trade (namely, the first trade and the second trade) and a given amount of funds (namely, the first amount of funds and the second amount of funds). A technical effect of the aforementioned feature is that each step is designed to verify a commitment of the first autonomous agent and the second autonomous agent towards each other and that required funds are reserved before processing, thus reducing a risk of failure or fraud.

The first autonomous agent reserves the first amount of funds for the first trade, which makes that first amount of funds unavailable for other use. After locking of the trade, a confirmation of said locking in a form of the first trade lock acknowledgment, is sent to the second autonomous agent. The first trade lock acknowledgment comprises the balance information of the first amount of funds that indicates how much of the funds are locked, and how much is the remaining funds. In this regard, the first autonomous agent interacts with the first smart contract to lock the trade.

Subsequently, upon receiving the first trade lock acknowledgment from the first autonomous agent, the balance information is verified by the second autonomous agent to determine whether the first amount of funds of the first autonomous agent is sufficient to cover the trade. Such verification beneficially maintains trust and ensures that the first autonomous agent has followed through. After this verification, the second trade is locked to reserve the second amount of funds. In this regard, the second autonomous agent interacts with the second smart contract to lock the second trade. This ensures that both parties are now equally committed, with funds reserved on both sides. After such locking, another confirmation, in a form of the second trade lock acknowledgment, is sent to the first autonomous agent. The second trade lock acknowledgment comprises the balance information of the second amount of funds that indicates how much of the funds are locked, and how much is the remaining funds.

Subsequently, both the first autonomous agent and the second autonomous agent locks funds for their respective trades, by accessing respective smart contracts to lock the funds. Herein, pre-locking the given amount of funds in a given smart contract (namely, the first smart contract and the second smart contract) refers to setting aside funds in advance for potential trades. Such pre-locking of funds in the given smart contract ensures that funds are readily available for trading. Beneficially, this speeds up the trading, and reduces a risk of a given autonomous agent (namely, first autonomous agent and the second autonomous agent) failing to lock required funds when the trade is initiated.

Subsequently, the first smart contract is configured to send a confirmation, in a form of the response, to ensure that the funds for the first trade have been successfully reserved. This ensures transparency and keeps the second autonomous agent informed about current state of the funds. Consequently, after the second autonomous agent locks the funds for the second trade, a confirmation is received, in a form of the response from the second smart contract. This ensures that the first autonomous agent and the second autonomous agent are fully aware of each other's commitments and current state of funds.

Optionally, when enabling the order book-based trade execution according to the funds push process,

the first autonomous agent is configured to verify the details of said locking of the funds for the second trade and the updated balance information of the second amount of funds, and to issue a first funds transfer order for the first smart contract upon said verification being successful, wherein the first smart contract is configured to execute the transfer of the funds for the first trade to the second user upon receiving the first funds transfer order;

the second autonomous agent is configured to verify the details of said locking of the funds for the first trade and the updated balance information of the first amount of funds, and to issue a second funds transfer order for the second smart contract upon said verification being successful, wherein the second smart contract is configured to execute the transfer of the funds for the second trade to the first user upon receiving the second funds transfer order.

Herein, the first autonomous agent uses the details received from the second autonomous agent to cross-check against the terms agreed upon for the second trade. This could involve checking a status of the funds in the smart contract and ensuring that the updated balance information matches expectations of the first autonomous agent. Such verification ensures that the second autonomous agent has fulfilled the agreed terms, specifically that the funds for the second trade are securely locked. This prevents the given user from attempting to execute a transfer without a corresponding lock. Upon successful verification, the first autonomous agent is configured to send a command, in a form of the first funds transfer order, to the first smart contract, instructing it to transfer the locked funds to the second user.

Moreover, the second autonomous agent performs verification that is similar to the verification performed by the first autonomous agent. Such verification is performed such that the second autonomous agent confirms that the first autonomous agent has fulfilled its side of the agreed terms. This is to prevent any issues or discrepancies that could lead to the given user not receiving their due funds. In this regard, the second autonomous agent reviews the details of locking of the funds and balance information received from the first autonomous agent to ensure that the trade parameters match, by interacting with the second smart contract. The second autonomous agent is configured to check the details provided by the first agent regarding locking of the funds for the first trade, including an updated balance information of the first amount of funds. Upon completion of the verification, the second autonomous agent is configured to instruct the second smart contract to execute the transfer, thus ensuring that the first user receives the funds for the second trade.

A technical effect of the aforementioned feature is that it ensures that transparency, security, and mutual trust between the first autonomous agent and the second autonomous agent, and prevents defaulting on the agreed terms.

Optionally, when enabling the order book-based trade execution according to the funds pull process,

the first autonomous agent is configured to verify the details of said locking of the funds for the second trade and the updated balance information of the second amount of funds, and to issue a first funds transfer order for the first smart contract upon said verification being successful, wherein the first smart contract is configured to execute the transfer of the funds for the first trade to the second user within a predefined time period, upon receiving the first funds transfer order from the first autonomous agent;

the second autonomous agent is configured to verify the details of said locking of the funds for the first trade and the updated balance information of the first amount of funds, and to issue a second funds transfer order for the second smart contract upon said verification being successful, wherein the second smart contract is configured to execute the transfer of the funds for the second trade to the first user within the predefined time period, upon receiving the second funds transfer order from the second autonomous agent;

each of: the first autonomous agent, the second autonomous agent, is configured to detect whether a trade execution error condition occurs on part of: the second user, the first user, respectively;

when the occurrence of the trade execution error condition is detected by the first autonomous agent, the first autonomous agent is configured to issue a first funds pull order to the second smart contract, wherein the second smart contract is configured to execute the transfer of the funds for the second trade to the first user, upon receiving the first funds pull order; and

when the occurrence of the trade execution error condition is detected by the second autonomous agent, the second autonomous agent is configured to issue a second funds pull order to the first smart contract, wherein the first smart contract is configured to execute the transfer of the funds for the first trade to the second user, upon receiving the second funds pull order.

Herein, the verification of the details of the locking of the funds for the second trade is performed in a similar manner as described above. However, the funds are to be transferred for the first trade from the first user to the second user within the predefined time period. Herein, the term "predefined time period" refers to duration of time that emulates a deadline, within which the trade is completed promptly, thereby reducing a risk of delays. Herein, in the predefined time period, the funds are temporarily locked until there is complete transfer of funds from both the first user and the second user. In this regard, the given smart contract could optionally be a HASH time-locked contract (HTLC). Subsequently, the verification of the details of the locking of the funds for the first trade is performed in a similar manner as described above. However, the funds are to be transferred for the second trade from the second user to the first user, within the predefined time period. Herein, by carrying out the trade within the predefined time period ensures that the trade is completed efficiently, which provides a certainty to both the first user and the second user.

Optionally, the predefined time period may be as little as 0.5 milliseconds up to a few hours, wherein 0.5 milliseconds is a time representative of an instantaneous bank transfer of funds and/or smart contract execution. Optionally, the predefined time period is within 0.5 milliseconds to 24 hours, for example from 0.5 seconds to 24hs. Herein, the predefined time period is a time period within which the funds transfer has to be executed. If the funds transfer is not executed, then funds pull order is given. In other words, any delayed execution of the smart contract is selected to further improve security of the decentralized transaction system such that it is ensured that said decentralized transaction system always has time to verify that the conditions for the fund transfer are met. The predefined time period may, for example, lie in a range of 0.5, 1, 10, 30, 60 (i.e., 1 minute), 600 (i.e., 10 minutes), 3000 (i.e., 50 minutes), 10800 (i.e., 180 minutes or 3 hours), 648000 (i.e., 10800 minutes or 10 hours), or 72000 seconds (i.e., 1200 minutes or 20 hours) to 2 seconds, 50, 100, 300 (5 minutes), 1800 (i.e., 30 minutes), 18000 (i.e., 300 minutes or 5 hours), 54000 (i.e., 900 minutes or 15 hours), 75600 (i.e., 1260 minutes or 21 hours), 86400 seconds (i.e., 1440 minutes or 24 hours).

Subsequently, both the first and the second autonomous agents are configured to monitor for the trade execution error condition during the trade execution process. These trade execution error condition might involve an issue on the part of the given user (for example, such as insufficient funds, failure to meet agreed terms, issues within the given smart contract and similar). Subsequently, upon detecting trade execution error condition, the first autonomous agent is configured to communicate with the second smart contract, instructing said smart contract, by way of the funds pull order, to execute the transfer of funds to the first user. This ensures that the first user does not suffer a loss due to the trade execution error condition. Herein, the funds pull order functions as a safeguard against failed and/or erroneous transactions. In case the trade execution error condition is detected, it is ensured that the first user is still compensated by receiving funds for the second trade. Similarly, in case the second autonomous agent detects the trade execution error condition during execution of the trade, the second autonomous agent is configured to communicate with the first smart contract instructing said smart contract, by way of the funds pull order, to execute the transfer of funds to the second user. In case the trade execution error condition is detected, it is ensured that the second user is still compensated by receiving funds for the first trade.

A technical effect of the aforementioned feature is that by verifying the locked funds, executing trades within the predefined time period, and detecting the trade execution error condition, a flow of the funds can be reversed. This ensures that the given user is compensated and that the trade remains fair and secure.

Optionally, the trade execution error condition that occurs on part of the first user, is one of:

the first autonomous agent failing to issue the first funds transfer order;

the first smart contract not receiving the first funds transfer order due to a fault in the communication interface;

the first smart contract failing to execute the transfer of the funds for the first trade to the second user within the predefined time period.

In this regard, the aforementioned trade execution error condition that occurs on part of the first user results in a situation where the second user does not receive the funds they are entitled to, causing potential disputes or requiring manual intervention to resolve. Herein, the first autonomous agent could fail to issue the first funds transfer order due to at least one of: a programming error within a code of the first autonomous agent, a logical error made by the first autonomous agent, a limitation of resources (for example, such as insufficient processing power, insufficient memory, and similar) experienced by the first autonomous agent, dependency of the first autonomous agent on an external system or another autonomous agent in the agent database. The failure to issue the first funds transfer order means that the trade cannot proceed as planned. Moreover, reasons for the fault in the communication interface could be at least one of: communication network issues, error in a software of the communication interface, security restrictions (for example, such as placing firewalls, access controls, and similar, that block or filter communication), mismatch of communication protocols of the first autonomous agent and the first smart contract. Furthermore, reasons for the first smart contract for failing to execute the transfer of the funds for the first trade to the second user within the predefined time period could be at least one of: a coding error in the first smart contract, execution delay of the first smart contract, insufficient computational work to execute the first smart contract, unpredictable changes in internal state of the smart contract (for example, due to another transaction affecting the same funds).

Optionally, the trade execution error condition that occurs on part of the second user, is one of: the second autonomous agent failing to issue the second funds transfer order; the second smart contract not receiving the second funds transfer order due to a fault in the communication interface; the second smart contract failing to execute the transfer of the funds for the second trade to the first user within the predefined time period.

In this regard, the aforementioned trade execution error condition that occurs on part of the second user results in a situation where the first user does not receive the funds they are entitled to, causing potential disputes or requiring manual intervention to resolve. Herein, the second autonomous agent could fail to issue the second funds transfer order due to at least one of: a programming error within a code of the second autonomous agent, a logical error made by the second autonomous agent, a limitation of resources (for example, such as insufficient processing power, insufficient memory, and similar) experienced by the second autonomous agent, dependency of the second autonomous agent on an external system or another autonomous agent in the agent database. The failure to issue the second funds transfer order means that the trade cannot proceed as planned. Moreover, reasons for the fault in the communication interface could be at least one of: the communication network issues, the error in a software of the communication interface, the security restrictions (for example, such as placing firewalls, access controls, and similar, that block or filter communication), mismatch of communication protocols of the second autonomous agent and the second smart contract. Furthermore, reasons for the second smart contract for failing to execute the transfer of the funds for the second trade to the first user within the predefined time period could be at least one of: a coding error in the second smart contract, execution delay of the second smart contract, insufficient computational work to execute the second smart contract, unpredictable changes in internal state of the smart contract (for example, due to another transaction affecting the same funds).

A technical effect of the trade execution error condition that occurs on the part of both the first user and the second user is that it is useful in designing the decentralized transaction system that is robust, which ensures that the first trade and the second trade can be completed successfully or be compensated when issues arise.

The present disclosure also relates to the second aspect as described above. Various embodiments and variants disclosed above, with respect to the aforementioned first aspect, apply mutatis mutandis to the second aspect.

Optionally, for enabling the order book-based trade locking and bilateral balance verification, the method comprises: configuring the first autonomous agent to lock the first trade and to send a corresponding first trade lock acknowledgment along with a balance information of the first amount of funds, to the second autonomous agent; configuring the second autonomous agent to verify the balance information of the first amount of funds, to lock the second trade, and to send a corresponding second trade lock acknowledgment along with a balance information of the second amount of funds, to the first autonomous agent;

configuring the first autonomous agent to lock funds for the first trade from amongst the first amount of funds that are pre-locked in the first smart contract, and configuring the second autonomous agent to lock funds for the second trade from amongst the second amount of funds that are pre-locked in the second smart contract;

configuring the first autonomous agent to send details of said locking of the funds for the first trade along with an updated balance information of the first amount of funds which remain in the first smart contract upon said locking of the funds for the first trade, to the second autonomous agent, upon receiving a response confirming said locking of the funds for the first trade, from the first smart contract; and

configuring the second autonomous agent to send details of said locking of the funds for the second trade along with an updated balance information of the second amount of funds which remain in the second smart contract upon said locking of the funds for the second trade, to the first autonomous agent, upon receiving a response confirming said locking of the funds for the second trade, from the second smart contract.

Optionally, when enabling the order book-based trade execution according to the funds push process, the method comprises: configuring the first autonomous agent to verify the details of said locking of the funds for the second trade and the updated balance information of the second amount of funds, and to issue a first funds transfer order for the first smart contract upon said verification being successful, wherein the first smart contract is configured to execute the transfer of the funds for the first trade to the second user upon receiving the first funds transfer order; configuring the second autonomous agent to verify the details of said locking of the funds for the first trade and the updated balance information of the first amount of funds, and to issue a second funds transfer order for the second smart contract upon said verification being successful, wherein the second smart contract is configured to execute the transfer of the funds for the second trade to the first user upon receiving the second funds transfer order.

Optionally, when enabling the order book-based trade execution according to the funds pull process, the method comprises: configuring the first autonomous agent to verify the details of said locking of the funds for the second trade and the updated balance information of the second amount of funds, and to issue a first funds transfer order for the first smart contract upon said verification being successful, wherein the first smart contract is configured to execute the transfer of the funds for the first trade to the second user within a predefined time period, upon receiving the first funds transfer order from the first autonomous agent;

configuring the second autonomous agent to verify the details of said locking of the funds for the first trade and the updated balance information of the first amount of funds, and to issue a second funds transfer order for the second smart contract upon said verification being successful, wherein the second smart contract is configured to execute the transfer of the funds for the second trade to the first user within the predefined time period, upon receiving the second funds transfer order from the second autonomous agent;

configuring each of: the first autonomous agent, the second autonomous agent, to detect whether a trade execution error condition occurs on part of: the second user, the first user, respectively;

when the occurrence of the trade execution error condition is detected by the first autonomous agent, configuring the first autonomous agent to issue a first funds pull order to the second smart contract, wherein the second smart contract is configured to execute the transfer of the funds for the second trade to the first user, upon receiving the first funds pull order; and

when the occurrence of the trade execution error condition is detected by the second autonomous agent, configuring the second autonomous agent to issue a second funds pull order to the first smart contract, wherein the first smart contract is configured to execute the transfer of the funds for the first trade to the second user, upon receiving the second funds pull order.

Optionally, the trade execution error condition that occurs on part of the first user, is one of:

the first autonomous agent failing to issue the first funds transfer order;

the first smart contract not receiving the first funds transfer order due to a fault in the communication interface;

the first smart contract failing to execute the transfer of the funds for the first trade to the second user within the predefined time period.

Optionally, the trade execution error condition that occurs on part of the second user, is one of:

the second autonomous agent failing to issue the second funds transfer order;

the second smart contract not receiving the second funds transfer order due to a fault in the communication interface;

the second smart contract failing to execute the transfer of the funds for the second trade to the first user within the predefined time period.

### DETAILED DESCRIPTION OF THE DRAWINGS

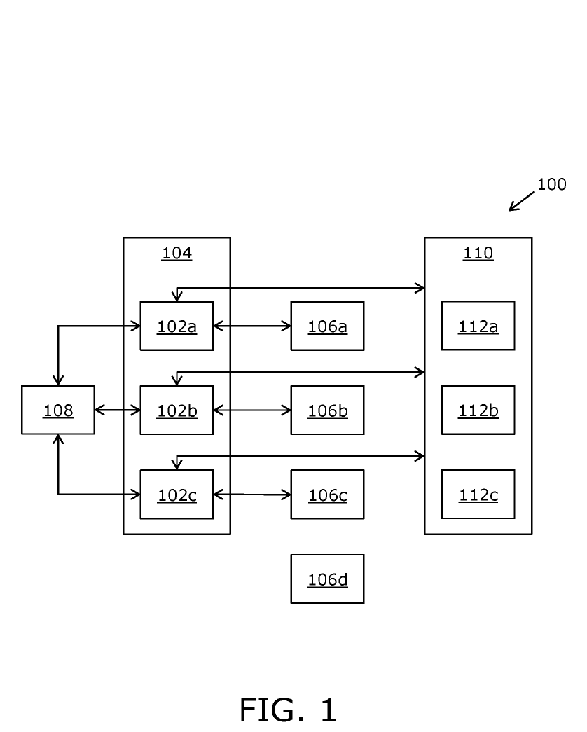

Referring to FIG. 1, illustrated is a decentralized transaction system 100, in accordance with an embodiment of the present disclosure. As shown, the decentralized transaction system 100 comprises a plurality of computing nodes (depicted as three computing nodes 102a, 102b, and 102c) configured to implement a platform 104 for enabling autonomous agent-based trading using a decentralized order book model. Herein, each computing node 102a-c is communicably coupled to its corresponding distributed ledger arrangement (depicted as three distributed ledger arrangements 106a, 106b, and 106c) from amongst a plurality of distributed ledger arrangements (depicted as distributed ledger arrangements 106a, 106b, 106c, and 106d), at least one user device (depicted as a user device 108), and an agent database 110 comprising a plurality of autonomous agents (depicted as three autonomous agents 112a, 112b, and 112c). In this regard, the computing node 102a is communicably coupled to distributed ledger arrangement 106a, the computing node 102b is communicably coupled to distributed ledger arrangement 106b, and the computing node 102c is communicably coupled to distributed ledger arrangement 106c. Moreover, the at least one computing node from amongst the computing nodes 102a-c is configured to perform various operations as described earlier with respect to the aforementioned first aspect.

FIG. 1 is merely an example, which should not unduly limit the scope of the claims herein. A person skilled in the art will recognize many variations, alternatives, and modifications of embodiments of the present disclosure.

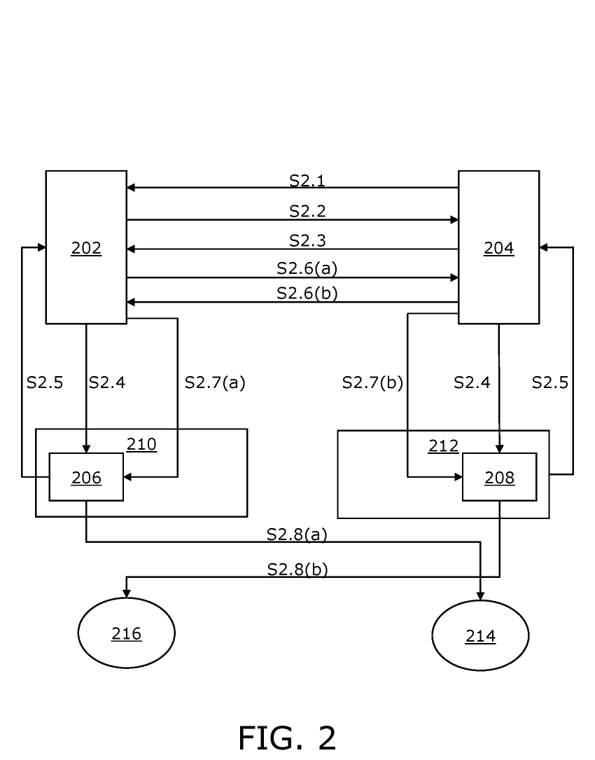

Referring to FIG. 2, there is shown an exemplary process flow of enabling order book-based trade execution according to a funds push process, in accordance with an embodiment of the present disclosure. At step S2.1, a first autonomous agent 202 is matched with a second autonomous agent 204. At step S2.2, the first autonomous agent 202 is configured to lock the first trade and to send a corresponding first trade lock acknowledgment along with a balance information of the first amount of funds, to the second autonomous agent 204. At step S2.3, the second autonomous agent 204 is configured to verify the balance information of the first amount of funds, to lock the second trade, and to send a corresponding second trade lock acknowledgment along with a balance information of the second amount of funds, to the first autonomous agent 202. At step S2.4, the first autonomous agent 202 is configured to lock funds for the first trade from amongst the first amount of funds that are pre-locked in a first smart contract 206, and the second autonomous agent 204 is configured to lock funds for the second trade from amongst the second amount of funds that are pre-locked in a second smart contract 208. Herein, the first smart contract 206 is executed on a first distributed ledger arrangement 210 and the second smart contract 208 is executed on a second distributed ledger arrangement 212. At step S2.5, a response confirming said locking of the funds for the first trade and the second trade, from the first smart contract 206 and the second smart contract 208, respectively, is sent to the first autonomous agent 202 and the second autonomous agent 204, respectively. At step S2.6(a), upon receiving the response confirming said locking of the funds for the first trade, from the first smart contract 206, the first autonomous agent 202 is configured to send details of said locking of the funds for the first trade along with an updated balance information of the first amount of funds which remain in the first smart contract 206 upon said locking of the funds for the first trade, to the second autonomous agent 204. At step S2.6(b), upon receiving the response confirming said locking of the funds for the second trade, from the second smart contract 208, the second autonomous agent 204 is configured to send details of said locking of the funds for the second trade along with an updated balance information of the second amount of funds which remain in the second smart contract 208 upon said locking of the funds for the second trade, to the first autonomous agent 202. At step S2.7(a), the first autonomous agent 202 is configured to verify the details of said locking of the funds for the second trade and the updated balance information of the second amount of funds, and to issue a first funds transfer order for the first smart contract 206 upon said verification being successful. At step S2.7(b), the second autonomous agent 204 is configured to verify the details of said locking of the funds for the first trade and the updated balance information of the first amount of funds, and to issue a second funds transfer order for the second smart contract 208 upon said verification being successful. At step S2.8(a), the first smart contract 206 is configured to execute the transfer of the funds for the first trade to a second user 214 upon receiving the first funds transfer order. At step S2.8(b), the second smart contract 208 is configured to execute the transfer of the funds for the second trade to a first user 216 upon receiving the second funds transfer order.

FIG. 2 is merely an example, which should not unduly limit the scope of the claims herein. A person skilled in the art will recognize many variations, alternatives, and modifications of embodiments of the present disclosure.

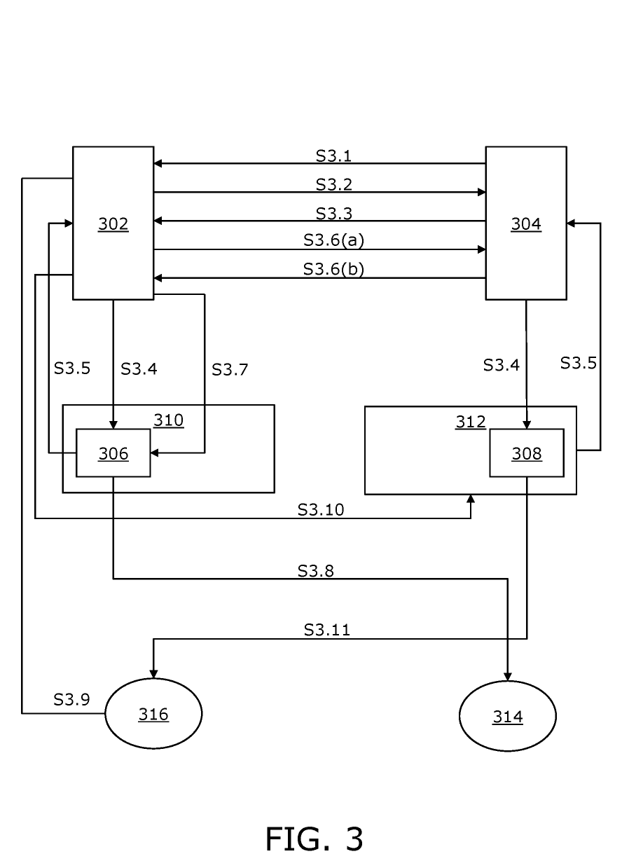

Referring to FIG. 3, there is shown an exemplary process flow of enabling order book-based trade execution according to a funds pull process, in accordance with an embodiment of the present disclosure. At step S3.1, a first autonomous agent 302 is matched with a second autonomous agent 304. At step S3.2, the first autonomous agent 302 is configured to lock the first trade and to send a corresponding first trade lock acknowledgment along with a balance information of the first amount of funds, to the second autonomous agent 304. At step S3.3, the second autonomous agent 304 is configured to verify the balance information of the first amount of funds, to lock the second trade, and to send a corresponding second trade lock acknowledgment along with a balance information of the second amount of funds, to the first autonomous agent 302. At step S3.4, the first autonomous agent 302 is configured to lock funds for the first trade from amongst the first amount of funds that are pre-locked in a first smart contract 306, and the second autonomous agent 304 is configured to lock funds for the second trade from amongst the second amount of funds that are pre-locked in the second smart contract 308. Herein, the first smart contract 306 is executed on a first distributed ledger arrangement 310 and the second smart contract 308 is executed on a second distributed ledger arrangement 312. At step S3.5, a response confirming said locking of the funds for the first trade and the second trade, from the first smart contract 306 and the second smart contract 308, respectively, is sent to the first autonomous agent 302 and the second autonomous agent 304, respectively. At step S3.6(a), upon receiving the response confirming said locking of the funds for the first trade, from the first smart contract 306, the first autonomous agent 302 is configured to send details of said locking of the funds for the first trade along with an updated balance information of the first amount of funds which remain in the first smart contract 306 upon said locking of the funds for the first trade, to the second autonomous agent 304. At step S3.6(b), upon receiving the response confirming said locking of the funds for the second trade, from the second smart contract 308, the second autonomous agent 304 is configured to send details of said locking of the funds for the second trade along with an updated balance information of the second amount of funds which remain in the second smart contract 308 upon said locking of the funds for the second trade, to the first autonomous agent 302. At step S3.7, the first autonomous agent 302 is configured to verify the details of said locking of the funds for the second trade and the updated balance information of the second amount of funds, and to issue a first funds transfer order for the first smart contract 306 upon said verification being successful. At step S3.8, the first smart contract 306 is configured to execute the transfer of the funds for the first trade to a second user 314 within a predefined time period, upon receiving the first funds transfer order from the first autonomous agent 302. Thereafter, the first autonomous agent 304 is configured to verify the details of said locking of the funds for the first trade and the updated balance information of the first amount of funds, and to issue a second funds transfer order for the second smart contract 308 upon said verification being successful, wherein the second smart contract 308 is configured to execute the transfer of the funds for the second trade to the first user 316 within the predefined time period, upon receiving the second funds transfer order from the first autonomous agent 304. At step S3.9, the first autonomous agent 302, is configured to detect whether a trade execution error condition occurs on part of the second user 314. At step S3.10, when the occurrence of the trade execution error condition is detected by the first autonomous agent 302, the first autonomous agent 302 is configured to issue a first funds pull order to the second smart contract 308. At step S3.11, the second smart contract 308 is configured to execute the transfer of the funds for the second trade to the first user 316, upon receiving the first funds pull order.

FIG. 3 is merely an example, which should not unduly limit the scope of the claims herein. A person skilled in the art will recognize many variations, alternatives, and modifications of embodiments of the present disclosure.

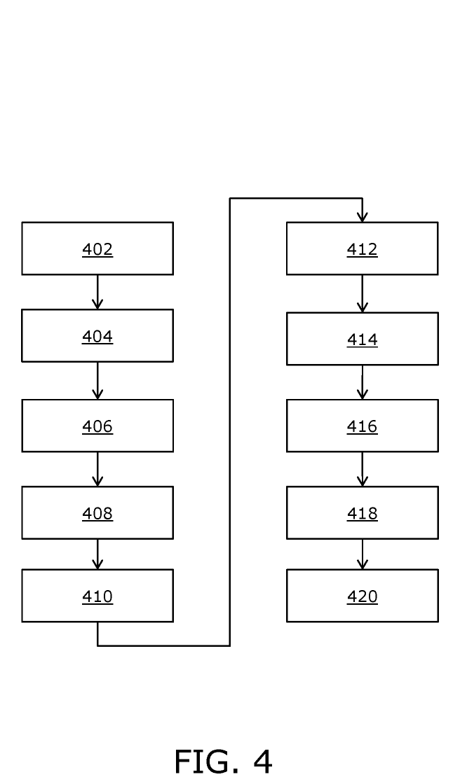

Referring to FIG. 4, illustrated is a flowchart depicting steps of a decentralized transaction method of operating a decentralized transaction system, in accordance with an embodiment of the present disclosure. At step 402, a first request is received for locking a first amount of funds, from a first user device, wherein upon receiving the first request, a first smart contract executing on a first distributed ledger arrangement is configured to lock the first amount of funds. At step 404, a second request is received for locking a second amount of funds, from a second user device, wherein upon receiving the second request, a second smart contract executing on a second distributed ledger arrangement is configured to lock the second amount of funds. At step 406, a third request is received, from the first user device, for placing a first trade on the platform. At step 408, a fourth request is received, from the second user device, for placing a second trade on the platform. At step 410, a first notification regarding placement of the first trade on the platform is sent, to the agent database, for a first autonomous agent associated with a first user of the first user device. At step 412, a second notification regarding placement of the second trade on the platform is sent, to the agent database, for a second autonomous agent associated with a second user of the second user device. At step 414, a communication interface is created for enabling peer to peer communication between the first autonomous agent and the second autonomous agent via the platform. At step 416, agent-based trade matching via the platform is facilitated via a processing interface, wherein the first autonomous agent is matched with the second autonomous agent when trade parameters of the first trade and trade parameters of the second trade match each other. At step 418, the processing interface is employed for enabling order book-based trade locking and bilateral balance verification via the platform, when the first autonomous agent is matched with the second autonomous agent. At step 420, the processing interface is employed for enabling order book-based trade execution via the platform, upon successful trade locking and bilateral balance verification, wherein the order book-based trade execution is enabled according to one of: a funds push process, a funds pull process.

The aforementioned steps are only illustrative and other alternatives can also be provided where one or more steps are added, one or more steps are removed, or one or more steps are provided in a different sequence without departing from the scope of the claims herein.

What is claimed is:

1. A decentralized transaction system (100) comprising a plurality of computing nodes (102a-c) configured to implement a platform (104) for enabling autonomous agent-based trading using a decentralized order book model, wherein each computing node is communicably coupled to its corresponding distributed ledger arrangement from amongst a plurality of distributed ledger arrangements (106a-c), at least one user device (108), and an agent database (110) comprising a plurality of autonomous agents (112a-c), and wherein at least one computing node is configured to:
receive a first request for locking a first amount of funds, from a first user device, wherein upon receiving the first request, a first smart contract (206, 306) executing on a first distributed ledger arrangement (210, 310) is configured to lock the first amount of funds;
receive a second request for locking a second amount of funds, from a second user device, wherein upon receiving the second request, a second smart contract (208, 308) executing on a second distributed ledger arrangement (212, 312) is configured to lock the second amount of funds;
receive, from the first user device, a third request for placing a first trade on the platform;
receive, from the second user device, a fourth request for placing a second trade on the platform;
send, to the agent database, a first notification regarding placement of the first trade on the platform, for a first autonomous agent (202, 302) associated with a first user (216, 316) of the first user device;
send, to the agent database, a second notification regarding placement of the second trade on the platform, for a second autonomous agent (204, 304) associated with a second user (214, 314) of the second user device;
create a communication interface for enabling peer to peer communication between the first autonomous agent and the second autonomous agent via the platform;
facilitate via a processing interface, agent-based trade matching via the platform, wherein the first autonomous agent is matched with the second autonomous agent when trade parameters of the first trade and trade parameters of the second trade match each other;
employ the processing interface for enabling order book-based trade locking and bilateral balance verification via the platform, when the first autonomous agent is matched with the second autonomous agent; and
employ the processing interface for enabling order book-based trade execution via the platform, upon successful trade locking and bilateral balance verification, wherein the order book-based trade execution is enabled according to one of: a funds push process, a funds pull process.

2. The decentralized transaction system (100) of claim 1, wherein for enabling the order book-based trade locking and bilateral balance verification,
the first autonomous agent (202, 302) is configured to lock the first trade and to send a corresponding first trade lock acknowledgment along with a balance information of the first amount of funds, to the second autonomous agent (204, 304);
the second autonomous agent is configured to verify the balance information of the first amount of funds, to lock the second trade, and to send a corresponding second trade lock acknowledgment along with a balance information of the second amount of funds, to the first autonomous agent;
the first autonomous agent is configured to lock funds for the first trade from amongst the first amount of funds that are pre-locked in the first smart contract (206, 306), and the second autonomous agent is configured to lock funds for the second trade from amongst the second amount of funds that are pre-locked in the second smart contract (208, 308);
upon receiving a response confirming said locking of the funds for the first trade, from the first smart contract, the first autonomous agent is configured to send details of said locking of the funds for the first trade along with an updated balance information of the first amount of funds which remain in the first smart contract upon said locking of the funds for the first trade, to the second autonomous agent; and
upon receiving a response confirming said locking of the funds for the second trade, from the second smart contract, the second autonomous agent is configured to send details of said locking of the funds for the second trade along with an updated balance information of the second amount of funds which remain in the second smart contract upon said locking of the funds for the second trade, to the first autonomous agent.

3. The decentralized transaction system (100) of claim 2, wherein when enabling the order book-based trade execution according to the funds push process,
the first autonomous agent (202, 302) is configured to verify the details of said locking of the funds for the second trade and the updated balance information of the second amount of funds, and to issue a first funds transfer order for the first smart contract (206, 306) upon said verification being successful, wherein the first smart contract is configured to execute the transfer of the funds for the first trade to the second user (214, 314) upon receiving the first funds transfer order;
the second autonomous agent (204, 304) is configured to verify the details of said locking of the funds for the first trade and the updated balance information of the first amount of funds, and to issue a second funds transfer order for the second smart contract (208, 308) upon said verification being successful, wherein the second smart contract is configured to execute the transfer of the funds for the second trade to the first user (216, 316) upon receiving the second funds transfer order.

4. The decentralized transaction system (100) of claim 2, wherein when enabling the order book-based trade execution according to the funds pull process,
the first autonomous agent (202, 302) is configured to verify the details of said locking of the funds for the second trade and the updated balance information of the second amount of funds, and to issue a first funds transfer order for the first smart contract (206, 306) upon said verification being successful, wherein the first smart contract is configured to execute the transfer of the funds for the first trade to the second user (214, 314) within a predefined time period, upon receiving the first funds transfer order from the first autonomous agent;
the second autonomous agent (204, 304) is configured to verify the details of said locking of the funds for the first trade and the updated balance information of the first amount of funds, and to issue a second funds transfer order for the second smart contract (208, 308) upon said verification being successful, wherein the second smart contract is configured to execute the transfer of the funds for the second trade to the first user (216, 316) within the predefined time period, upon receiving the second funds transfer order from the second autonomous agent;
each of: the first autonomous agent, the second autonomous agent, is configured to detect whether a trade execution error condition occurs on part of: the second user, the first user, respectively;
when the occurrence of the trade execution error condition is detected by the first autonomous agent, the first autonomous agent is configured to issue a first funds pull order to the second smart contract, wherein the second smart contract is configured to execute the transfer of the funds for the second trade to the first user, upon receiving the first funds pull order; and
when the occurrence of the trade execution error condition is detected by the second autonomous agent, the second autonomous agent is configured to issue a second funds pull order to the first smart contract, wherein the first smart contract is configured to execute the transfer of the funds for the first trade to the second user, upon receiving the second funds pull order.

5. The decentralized transaction system (100) of claim 4, wherein the trade execution error condition that occurs on part of the first user (216, 316), is one of:
the first autonomous agent (202, 302) failing to issue the first funds transfer order;
the first smart contract (206, 306) not receiving the first funds transfer order due to a fault in the communication interface;
the first smart contract failing to execute the transfer of the funds for the first trade to the second user (214, 314) within the predefined time period.

6. The decentralized transaction system (100) of claim 4, wherein the trade execution error condition that occurs on part of the second user (214, 314), is one of:
the second autonomous agent (204, 304) failing to issue the second funds transfer order;
the second smart contract (208, 308) not receiving the second funds transfer order due to a fault in the communication interface;
the second smart contract failing to execute the transfer of the funds for the second trade to the first user (216, 316) within the predefined time period.

7. The decentralized transaction system (100) of claim 4, wherein the predefined time period lies in a range of 0.01 second to 24 hours.

8. The decentralized transaction system (100) of claim 1, wherein the trade parameters of the first trade comprises at least one of: a timeframe needed for completion of the first trade, a cost associated with the first trade, a quantity associated with the first trade, a quality associated with the first trade, a customized instruction associated with the first trade, an asset type, a preference of the autonomous agents (112a-c), or delivery terms.

9. The decentralized transaction system (100) of claim 1, wherein the trade parameters of the second trade comprises at least one of: a timeframe needed for completion of the second trade, a cost associated with the second trade, a quantity associated with the second trade, a quality associated with the second trade, a customized instruction associated with the second trade, an asset type, a preference of the autonomous agents (112a-c), or delivery terms.

10. A decentralized transaction method of operating a decentralized transaction system (100) that comprises a plurality of computing nodes (102a-c) configured to implement a platform (104) for enabling autonomous agent-based trading using a decentralized order book model, wherein each computing node is communicably coupled to its corresponding distributed ledger arrangement from amongst a plurality of distributed ledger arrangements (106a-c), at least one user device (108), and an agent database (110) comprising a plurality of autonomous agents (112a-c), the method comprising:
receiving a first request for locking a first amount of funds, from a first user device, wherein upon receiving the first request, a first smart contract (206, 306) executing on a first distributed ledger arrangement (210, 310) is configured to lock the first amount of funds;
receiving a second request for locking a second amount of funds, from a second user device, wherein upon receiving the second request, a second smart contract (208, 308) executing on a second distributed ledger arrangement (212, 312) is configured to lock the second amount of funds;
receiving, from the first user device, a third request for placing a first trade on the platform;
receiving, from the second user device, a fourth request for placing a second trade on the platform;
sending, to the agent database, a first notification regarding placement of the first trade on the platform, for a first autonomous agent (202, 302) associated with a first user (216, 316) of the first user device;
sending, to the agent database, a second notification regarding placement of the second trade on the platform, for a second autonomous agent (204, 304) associated with a second user (214, 314) of the second user device;
creating a communication interface for enabling peer to peer communication between the first autonomous agent and the second autonomous agent via the platform;
facilitating via a processing interface, agent-based trade matching via the platform, wherein the first autonomous agent is matched with the second autonomous agent when trade parameters of the first trade and trade parameters of the second trade match each other;
employing the processing interface for enabling order book-based trade locking and bilateral balance verification via the platform, when the first autonomous agent is matched with the second autonomous agent; and
employing the processing interface for enabling order book-based trade execution via the platform, upon successful trade locking and bilateral balance verification, wherein the order book-based trade execution is enabled according to one of: a funds push process, a funds pull process.

11. The decentralized transaction method of claim 10, wherein for enabling the order book-based trade locking and bilateral balance verification, the method comprises:
configuring the first autonomous agent (202, 302) to lock the first trade and to send a corresponding first trade lock acknowledgment along with a balance information of the first amount of funds, to the second autonomous agent (204, 304);
configuring the second autonomous agent to verify the balance information of the first amount of funds, to lock the second trade, and to send a corresponding second trade lock acknowledgment along with a balance information of the second amount of funds, to the first autonomous agent;
configuring the first autonomous agent to lock funds for the first trade from amongst the first amount of funds that are pre-locked in the first smart contract (206, 306), and configuring the second autonomous agent to lock funds for the second trade from amongst the second amount of funds that are pre-locked in the second smart contract (208, 308);
configuring the first autonomous agent to send details of said locking of the funds for the first trade along with an updated balance information of the first amount of funds which remain in the first smart contract upon said locking of the funds for the first trade, to the second autonomous agent, upon receiving a response confirming said locking of the funds for the first trade, from the first smart contract; and
configuring the second autonomous agent to send details of said locking of the funds for the second trade along with an updated balance information of the second amount of funds which remain in the second smart contract upon said locking of the funds for the second trade, to the first autonomous agent, upon receiving a response confirming said locking of the funds for the second trade, from the second smart contract.

12. The decentralized transaction method of claim 11, when enabling the order book-based trade execution according to the funds push process, the method comprises:
configuring the first autonomous agent (202, 302) to verify the details of said locking of the funds for the second trade and the updated balance information of the second amount of funds, and to issue a first funds transfer order for the first smart contract (206, 306) upon said verification being successful, wherein the first smart contract is configured to execute the transfer of the funds for the first trade to the second user (214, 314) upon receiving the first funds transfer order;
configuring the second autonomous agent (204, 304) to verify the details of said locking of the funds for the first trade and the updated balance information of the first amount of funds, and to issue a second funds transfer order for the second smart contract (208, 308) upon said verification being successful, wherein the second smart contract is configured to execute the transfer of the funds for the second trade to the first user (216, 316) upon receiving the second funds transfer order.

13. The decentralized transaction method of claim 11, wherein when enabling the order book-based trade execution according to the funds pull process, the method comprises:
configuring the first autonomous agent (202, 302) to verify the details of said locking of the funds for the second trade and the updated balance information of the second amount of funds, and to issue a first funds transfer order for the first smart contract (206, 306) upon said verification being successful, wherein the first smart contract is configured to execute the transfer of the funds for the first trade to the second user (214, 314) within a predefined time period, upon receiving the first funds transfer order from the first autonomous agent;
configuring the second autonomous agent (204, 304) to verify the details of said locking of the funds for the first trade and the updated balance information of the first amount of funds, and to issue a second funds transfer order for the second smart contract (208, 308) upon said verification being successful, wherein the second smart contract is configured to execute the transfer of the funds for the second trade to the first user (216, 316) within the predefined time period, upon receiving the second funds transfer order from the second autonomous agent;
configuring each of: the first autonomous agent, the second autonomous agent, to detect whether a trade execution error condition occurs on part of: the second user, the first user, respectively;
when the occurrence of the trade execution error condition is detected by the first autonomous agent, configuring the first autonomous agent to issue a first funds pull order to the second smart contract, wherein the second smart contract is configured to execute the transfer of the funds for the second trade to the first user, upon receiving the first funds pull order; and
when the occurrence of the trade execution error condition is detected by the second autonomous agent, configuring the second autonomous agent to issue a second funds pull order to the first smart contract, wherein the first smart contract is configured to execute the transfer of the funds for the first trade to the second user, upon receiving the second funds pull order.

14. The decentralized transaction method of claim 13, wherein the trade execution error condition that occurs on part of the first user (216, 316), is one of:
the first autonomous agent (202, 302) failing to issue the first funds transfer order;
the first smart contract (206, 306) not receiving the first funds transfer order due to a fault in the communication interface;
the first smart contract failing to execute the transfer of the funds for the first trade to the second user (214, 314) within the predefined time period.

15. The decentralized transaction method of claim 13, wherein the trade execution error condition that occurs on part of the second user (214, 314), is one of:
the second autonomous agent (204, 304) failing to issue the second funds transfer order;
the second smart contract (208, 308) not receiving the second funds transfer order due to a fault in the communication interface;
the second smart contract failing to execute the transfer of the funds for the second trade to the first user (216, 316) within the predefined time period.
